(19) United States
(12) Patent Application Publication
(10) Pub. No.: US 2007/0157980 A1
(43) Pub. Date: Jul. 12, 2007

(54) Pilot operated control valve having a two stage poppet

(75) Inventors: Dwight B. Stephenson, Oconomowoc, WI (US); Gennady Shimelfarb, Waukesha, WI (US); Joseph L. Pfaff, Wauwatosa, WI (US)

Correspondence Address: QUARLES & BRADY LLP, 411 E. WISCONSIN AVENUE, SUITE 2040, MILWAUKEE, WI, 53202-4497, US

(73) Assignee: HUSCO International, Inc.

(21) Appl. No.: 11/329,664

(22) Filed: Jan. 11, 2006

(51) Int. Cl. F15B 13/043

(52) U.S. Cl. 137/625.64

(57) ABSTRACT

A hydraulic valve has a main poppet that engages and disengages a valve seat to control the flow of fluid between an inlet and an outlet. Movement of the main poppet is governed by a pilot valve element the opens and closes a pilot passage in the main poppet. The pilot valve element is slideably received in a bore in an armature. The armature is biased toward the main poppet by a first spring and a second spring biases the pilot valve element outward from armature bore and toward the main poppet. The second spring has a lesser spring rate than the first spring. Upon engagement of the pilot valve element with the main poppet continued application of the engaging force causes the second spring to collapse and the pilot valve element to slide within the armature, thereby absorbing some of the force that could otherwise adversely affect the valve.

### BACKGROUND OF THE INVENTION

1. Field of the Invention

The present invention relates to pilot operated hydraulic valves, and more particularly to such valves which incorporate mechanisms that compensate for the effect that change in a pressure differential across the valve has on flow through the valve.

2. Description of the Related Art

There is a current trend in hydraulic systems to use electrical control and the electrically operated hydraulic valves. This type of control simplifies the hydraulic plumbing as the control valves do not have to be located in close proximity to the operator cab and facilitates computerized operation of various machine functions.

A solenoid actuated pilot valve is a well known electrically operated device that controls the flow of hydraulic fluid. This valve has nose port at an end of a bore, a side port that opens laterally into the bore, and a valve seat between the ports. A poppet engages and disengages the valve seat to close and open a fluid path between the two ports. Fluid flows through the valve in a forward direction from the side port to the nose port. A bidirectional valve also is able to control flow in a reverse direction, from the nose port to the side port.

Movement of the poppet is governed by pressure in a control chamber on a remote side of the poppet from the valve seat. Energizing an electromagnetic coil moves an pilot valve element that opens a pilot passage through the poppet, thereby releasing pressure in the control chamber so that the poppet can move away from the valve seat. The flow through some types of pilot operated poppet valves can be varied by controlling the level of electrical current applied to the electromagnetic coil and thus the distance that the poppet moves away from the valve seat. The resultant fluid flow is related to the electrical current level and these valves are referred to as proportional valves. When the electromagnetic coil is deenergized, a spring biases the pilot valve element to block the pilot passage so that pressure increases in the control chamber and forces the poppet against the valve seat, closing the valve.

When a conventional pilot operated, poppet valve is commanded to close and the electric current is removed from the solenoid coil, the electromagnetic force diminishes quickly. This results in the pilot valve element moving faster in response to the spring force than the speed at which the poppet moves toward the valve seat. Therefore, the pilot valve element is forcibly pushed into an opening of the pilot passage in the poppet, which over time adversely affects the pilot valve element and the opening of the pilot passage.

When fluid is flowing in the reverse direction through the valve, the flow force pushes the poppet against the pilot valve element collapsing the spring that acts on the pilot valve element. This action drives the pilot valve element into the pilot passage in the poppet which also adversely affects the service life of the valve.

Therefore, it is desirable to provide a mechanism that balances or reduces these forces that drive the pilot valve element into the pilot passage of the poppet.

### SUMMARY OF THE INVENTION

A hydraulic control valve comprises a body having a first bore with a valve seat formed therein. A first port opens transversely into the first bore on one side of the valve seat and a second port communicates with the first bore on another side of the valve seat. A main poppet selectively engages and disengages the valve seat to control flow of fluid between the first and second ports, and a control chamber is formed within the first bore on one side of the main poppet. The main poppet has a pilot passage with openings into the control chamber and the second port.

An actuator includes an armature that moves within the body and that has a second bore therein. A first spring biases the armature with respect to the body. A pilot valve element is slideably received within the second bore to selectively open and close the pilot orifice as the armature moves. That opening and closing action controls pressure within the control chamber in a conventional manner used in prior pilot operated valves. A second spring biases the pilot valve element with respect to the armature. The second spring has a lesser spring rate than the first spring, wherein upon engagement of the pilot valve element with the main poppet, further application of a force that pushes the pilot valve element and the main poppet together causes the second spring to collapse and the pilot valve element to slide within the armature. This latter sliding action absorbs some of the force that could otherwise adversely affect the service life of the valve.

In a preferred embodiment of the hydraulic control valve, the pilot valve element has a member that limits the amount that the pilot valve element is able to slide within the armature toward the main poppet.

A bidirectional version of a hydraulic valve incorporating the present invention also is disclosed. That valve's pilot passage also opens into the first port and check valves are located at the pilot passage openings into both ports.

### BRIEF DESCRIPTION OF THE DRAWINGS

FIG. 1 is a cross sectional view through a solenoid operated hydraulic valve according to the present invention;

FIG. 2 is a cross sectional view through a second embodiment of a solenoid operated hydraulic valve; and

FIG. 3 is a schematic diagram of a hydraulic circuit that utilizes hydraulic valves according to the present invention.

### DETAILED DESCRIPTION OF THE INVENTION

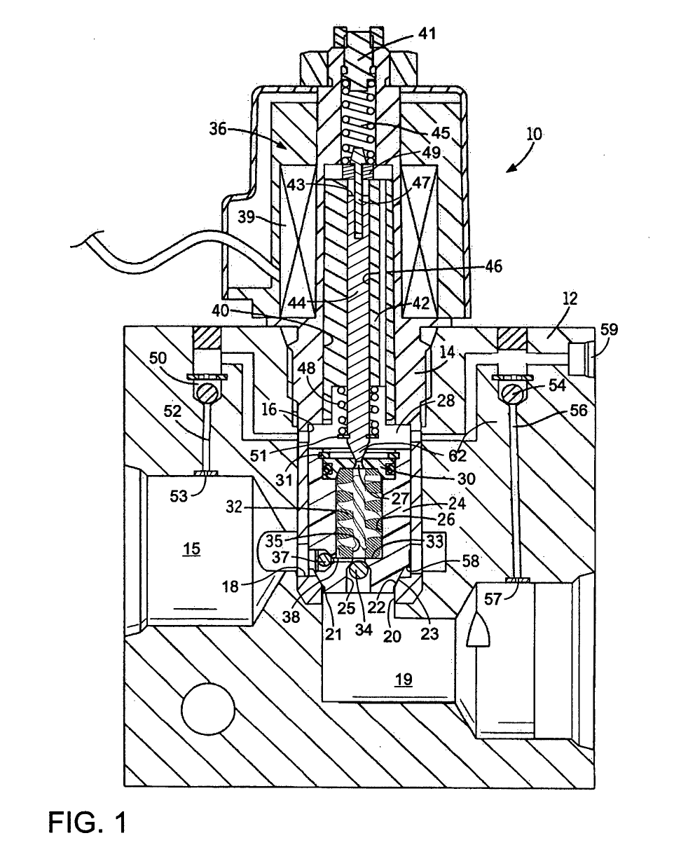

With reference to FIG. 1, a solenoid operated hydraulic valve 10 comprises a cylindrical cartridge type body 14 mounted in a longitudinal first bore 16 of a valve manifold 12. The valve manifold 12 has a transverse first conduit 15 which opens into first port 18 at the side of the first bore 16. A second conduit 19 extends through the valve manifold 12 and communicates with a second port 20 at the interior end of the first bore 16. A valve seat 22 is formed in the first bore 16 between the first and second ports 18 and 20.

A main poppet 24 slides within the first bore 16 with respect to the valve seat 22 to selectively control flow of hydraulic fluid between the first and second ports 18 and 20. An aperture 26 is centrally located in the main poppet 24 and extends from a first opening at the second port 20 to a second opening into a control chamber 28 on the remote side of the main poppet. The poppet aperture 26 has a shoulder 33 spaced from the first opening.

The nose of the main poppet 24 has a frustoconical surface 23 that in the closed state of the valve engages the valve seat 22. The frustoconical surface 23 terminates at a cylindrical nose 21 that projects into second port 20.

A first check valve 34 forms a flow control element that is located in a first pressure passage 25 in the main poppet 24 between the shoulder 33 and the first opening to allow fluid to flow only from the poppet aperture 26 into the second port 20. A flow control element comprising a second check valve 37 is located within the main poppet 24 in a transverse second pressure passage 38 that extends between the first port 18 and the poppet aperture 26 adjacent the shoulder 33. The second check valve 37 limits fluid flow in the passage 38 to only a direction from the poppet aperture 26 into the first port 18. Both flow passages controlled by the first and second check valves 34 and 37 are in constant communication with the aperture 26 in the main poppet 24.

The opening of the poppet aperture 26 into the control chamber 28 is closed by a flexible pilot seat 30 that has a pilot aperture 27 there through. The pilot seat 30 is held in place by a snap ring 31. A double helical spring 32 within the poppet 24 biases the pilot seat 30 with respect to the shoulder 33 of the poppet aperture 26. Opposite sides of the pilot seat 30 are exposed to the pressures in the control chamber 28 and a pilot passage 35 that extends through the double helical spring 32 in the main poppet 24.

The valve manifold 12 has a first control passage 52 extending between the control chamber 28 and the first port 18 with a flow control element comprising a third check valve 50 in that passage 52. The third check valve 50 that allows fluid to flow only in the direction from the first port 18 to the control chamber 28. A second control passage 56 is provided in the valve manifold 12 and has another flow control element, specifically a fourth check valve 54, therein which limits fluid flow only from the second port 20 into the control chamber 28. Both of these control passages 52 and 56 have first and second flow restricting orifices 53 and 57, respectively. Note that the control chamber 28 is connected directly to a control port 59 in the valve manifold 12 that enables external devices to be connected to the control chamber as will be described.

Movement of the main poppet 24 is controlled by a solenoid actuator 36 comprising an electromagnetic coil 39, an armature 42 and a pilot valve element 44. The armature 42 is positioned within a bore 40 through the valve body 14 and is biased toward the main poppet 24 by a first, or modulating, spring 45 that exerts a force which can be varied by an adjusting screw 41 threaded into an exposed end of the cartridge bore 40. The electromagnetic coil 39 is located around and secured to valve body 14. The armature 42 slides within the cartridge bore 40 away from main poppet 24 in response to an electromagnetic field created by applying electric current to the electromagnetic coil 39.

The pilot valve element 44 is slideably received in a second bore 46 of the tubular armature 42. A second spring 48, that engages a snap ring 51 secured to the pilot valve element, biases the pilot valve element 44 outward from that second bore 46 so that a proximate end with a conical tip 62 enters the pilot aperture 27. A remote end 43 of the pilot valve element 44 is recessed within second bore 46 from the adjacent end of the armature 42 when the hydraulic valve 10 is in the closed state as illustrated. That pilot valve element remote end 43 has an aperture therein within which a pull pin 47 is press fitted. The pull pin 47 has an exterior head that engages a washer 49 which is held between the end of the armature 42 and the first spring 45. A gap is created between the washer 49 and the adjacent end 43 of the pilot valve element 44 that allows the pilot valve element to slide upward within the armature 42 against the force of the second spring 48. The first spring 45 has a significantly greater spring rate than the second spring 48 so that force applied to the tip of the pilot valve element 44 will produce that sliding action before the armature 42 compresses the first spring, as will be described.

In the de-energized state of the electromagnetic coil 39, the first spring 45 forces the armature 42 toward the main poppet 24, while the second spring 48 forces the pilot valve element 44 outward from the armature so that the conical tip 62 enters and closes the pilot aperture 27. This combined action results in the pilot valve element tip 62 closing the pilot passage 35 and blocking fluid communication between the control chamber 28 and both the first and second ports 18 and 20. At the same time the third and fourth check valves 50 and 54 also block any fluid from exiting the control chamber 28 while allowing the pressure in the control chamber to be at least as great as the higher pressure at the first and second ports. As a consequence, the pressure within the control chamber 28 resists forces that tend to move the main poppet 24 from the main valve seat 22 and open the hydraulic valve 10.

Energizing the solenoid actuator 36 enables the hydraulic valve 10 to proportionally control the flow of hydraulic fluid between the first and second ports 18 and 20. Electric current applied to the electromagnetic coil 39 generates an electromagnetic field which draws the armature 42 into the solenoid actuator 36 and away from the main poppet 24. The magnitude of that electric current determines the degree to which the valve opens and thus the amount of fluid flow through the valve is proportional to that current. The valve is bidirectional being able to control fluid flow in either direction between the ports.

When the pressure at the first port 18 exceeds the pressure at the second port 20, the higher pressure is communicated to the control chamber 28 through orifice 53, first pressure passage 52 and the third check valve 50. The solenoid actuator's electromagnetic field causes the armature 42 to move upward in FIG. 1 which also draws the pull pin 47 and the pilot valve element 44 upward. This action moves the pilot valve element tip 62 away from the main poppet 24, thereby opening the pilot aperture 27 and releasing pressure in the control chamber 28 to the second port 20 which in this instance has a lower relative pressure. As a result, a greater pressure from the first port 18 acts on surface 58 of the main poppet than acts on the main poppet surface in the control chamber 28. That pressure difference forces the frustoconical surface 23 away from valve seat 22, thereby opening direct communication between the first and second ports 18 and 20. The resultant opening allows fluid to flow in a forward direction through the hydraulic valve 10 from the first port 18 to the second port 20.

Movement of the main poppet 24 continues until a pressure/force balance is established across the main poppet due to constant flow through the effective opening of the pilot aperture 27. Thus, the size of this valve opening and the flow rate of hydraulic fluid there through are determined by the position of the armature 42 and pilot valve element 44, which in turn controlled by the magnitude of current in electromagnetic coil 39.

Fluctuation of the load and supply pressures produces a varying pressure differential across the valve that may affect the magnitude of electrical current required to operate the valve. In hydraulic valve 10, the effect that the pressure differential has on the main poppet 24 is counterbalanced by the flexible pilot seat 30 that is biased by the double helical spring 32. The double helical spring 32 enables the pilot seat 30 to move in response to changes in the pressure differential across the main poppet 24. Such movement effectively alters the axial position of the pilot seat 30 to offset the effects of pressure differential changes on the pilot valve. The design flexibility of the pilot seat is determined based on the spring rate of the double helical spring 32.

When the solenoid actuator 36 is deenergized to close the hydraulic valve 10, the high rate modulating, first spring 45 drives the armature 42 toward the main poppet 24. The pilot valve element 44 is carried along with the movement of the armature 42 until the conical tip 62 engages the pilot seat 30 of the main poppet 24. That engagement resists further motion of the pilot valve element 44, thereby collapsing the second spring 48 and allowing the armature 42 to slide over the pilot valve element. Therefore, some of the force, that in prior valves was transferred to the wall of the pilot aperture 27 in the main poppet 24, is absorbed by the collapse of the second spring 48.

When the hydraulic valve 10 controls flow in the reverse direction, pressure in the second port 20 exceeds the pressure in the first port 18. In this case the higher second port pressure is communicated into the control chamber 28 through orifice 57, the second control passage 56, and the fourth check valve 54. Upon the electromagnetic coil 39 being energized, the pilot valve element 44 moves out of the pilot aperture 27 releasing the pressure in the control chamber 28 and allowing the second port's pressure to move the main poppet 24 away from the valve seat 22. This proportional flow control is similar to that described previously for flow in the forward direction.

However, as the pressure in the second port 20 drives the main poppet 24 against the pilot valve element tip 62, the first spring 45 collapses to absorb some of that force and mitigate the potential adverse affects on the pilot valve element tip and the pilot aperture 27.

In addition, the collapsing pilot valve element design with the dual springs 45 and 48 enables the main poppet 24 to travel a greater distance within the first bore 16 than the amount that the armature 42 of the solenoid actuator 36 is able to travel. Note that the gap in the control chamber 28 in which the main poppet 24 moves is greater that the gap above the upper end of the armature 42. Therefore, when the armature 42 reaches the extreme upward end of its travel, the pilot valve element 44 is capable of further upward motion within the second bore 46 in the armature, which allows the main poppet 24 to move farther upward away from the valve seat 22. This increased travel distance of the main poppet 24 increases the flow through the valve.

For example, when the hydraulic valve 10 is controlling the flow of fluid from the second port 20 to the first port 18 pressure is greater in the second port. That greater pressure is applied to the relatively large surface area at the nose 21 of the main poppet 24. Although the armature may be at the extreme upward end of its travel, the main poppet still is forced farther open as the pilot valve element moves upward within the armature collapsing the second spring 48.

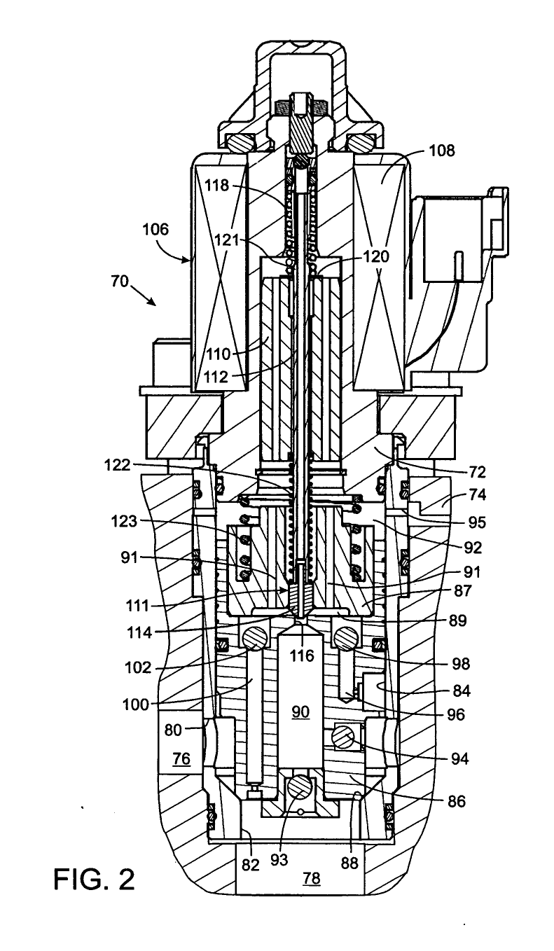

FIG. 2 illustrates a second hydraulic valve 70 which incorporates the present invention. That second hydraulic valve 70 has a cylindrical valve body 72 that is mounted within an aperture of a manifold 74 which has first and second fluid passages 76 and 78. The first fluid passage opens through a first port 80 in the valve body 72, while the nose of the valve body has a second port 82 in communication with the second passage 78. The valve body 72 has a tubular configuration with an internal bore 84 in which a main poppet 86 is slidably received to selectively engage a valve seat 88 to open and close communication between the first and second ports 80 and 82.

The end of the poppet 86, that is remote end from the valve seat, has a recess within which a valve piston 87 is received, thereby defining an intermediate chamber 89 there between. Fluid passages 91 extend through the valve piston 87 between the intermediate chamber 89 and a control chamber 92 on the opposite side of the poppet 86. Thus the intermediate and control chambers 89 and 92 are in constant fluid communication with each other. A control port 95 enables the control chamber 92 to be connected to an external device, as will be described.

The main poppet 86 has a pilot passage 90 between the second port 82 and the intermediate chamber 89 on the opposite side from the valve seat 88. A first check valve 93 in a branch passage permits fluid to flow only from the pilot passage 90 to the first port 80. A second check valve 94 allows fluid flow only from the in the pilot passage 90 into the second port 82. A first control passage 96 extends between the first port 80 to the intermediate chamber 89 and on into the control chamber 92 and has a third check valve 98 therein that allows fluid to flow through that passage only in a direction to the control chamber. A second control passage 100 extends between the second port 82 and the intermediate and control chambers 89 and 92 with a fourth check valve 102 that enables fluid to flow only from that second port to those chambers.

The second hydraulic valve 70 has a solenoid actuator 106 with an electromagnetic coil 108 within which an armature 110 is slideably received. A first spring 118 presses a washer 120 against an end surface of the armature 110 thereby biasing the armature toward the main poppet 86. The solenoid actuator 106 has a pilot valve element 111 that comprises a pilot pin 112 attached to a pilot poppet 114, which may be separate pieces or formed as a single piece. The elongated, tubular pilot pin 112 extends through a bore in the armature 110 and into an aperture within the valve piston 87. An end of the pilot pin 112 that is within the solenoid actuator 106 has an annular rib 121 that abuts the washer 120 in the illustrated state of the valve and limits downward travel of the pilot pin. The opposite end of the pilot pin 112, that extends into the piston 87, is attached to the pilot poppet 114 which selectively engages a pilot aperture 116 where the pilot passage 90 opens into the intermediate chamber 89. A second spring 122 biases the pilot poppet 114 away from the opposite end of the armature 110 and into the pilot aperture 116 to close that aperture. A third spring 123 biases the valve piston 87, and thus the main poppet 86, away from the solenoid actuator 106.

As with the first valve 10 in FIG. 1, pressure at the second port 82 can exert force on the main poppet 86 and valve piston 87 which causes the pilot valve element 111 to slide within the armature 110 and absorb forces that otherwise could damage the sealing surfaces of the pilot poppet 114 and the pilot aperture 116. The ability of the pilot valve element 111 to move with respect to the position of the armature 110 also enables the main poppet 86 to move a greater distance with respect to the main valve seat 88 than the distance that the armature 110 is able to move.

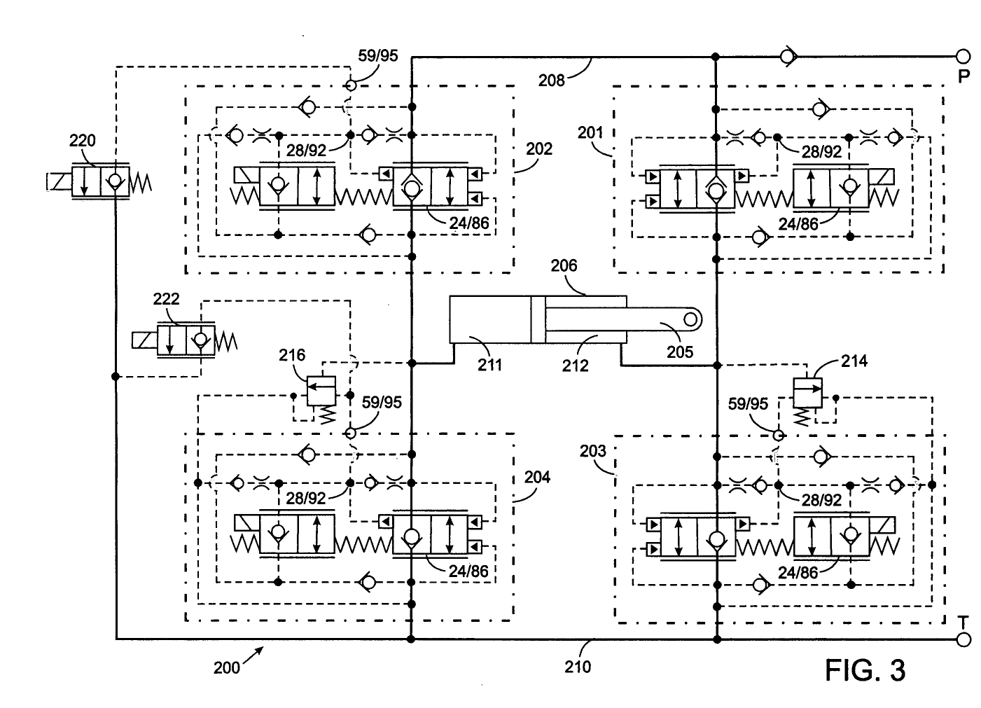

FIG. 3 illustrates an exemplary hydraulic circuit 200 for an excavator in which the hydraulic valve 10 or 70 is utilized. The hydraulic circuit 200 employs four such valves as four control valves 201-204 which couple a boom cylinder 206 to a pump supply line 208 and a tank return line 210. The cylinder 206 has a head chamber 211 and a rod chamber 212. A first control valve 201 connects the pump supply line 208 to the rod chamber 212 and a second control valve 202 provides a connection between the pump supply line and the head chamber 211. The third control valve 203 couples the rod chamber 212 to the tank return line 210, while the fourth control valve 204 provides a similar connection between the head chamber 211 and the tank return line 210.

A first pressure relief valve 214 connects the control port 59 or 95 of the third control valve 203 to the tank return line 210 when pressure within the rod chamber 212 of cylinder 206 exceeds a predefined threshold. That action releases the pressure in the control chamber 28 or 92 of the third control valve 203 thereby allows its main poppet 24 or 86 to open in response to the pressure in the rod chamber 212 to open. Thus a path in created between the rod chamber 212 and the tank return line 210 which relieves the excessive pressure within that chamber. This arrangement utilizes a relatively low flow and physically small pressure relief valve 214 and enables the third control valve 203 to act as the primary pressure relief conduit. A similar pressure relief valve 216 is provided at the control port 59 or 95 of the fourth control valve 204 to open that control valve in response to excessive pressure within the head chamber 211 of the cylinder 206.

The cylinder 206 for the boom of an excavator has a piston rod 255 with a relatively large diameter. Therefore, the head chamber 211 has a significantly greater volume than rod chamber 212 when the piston is centered within the cylinder. As a consequence, fluid must flow to and from the head chamber 211 at a greater rate than fluid exhausting from the rod chamber 212 in order to move the piston rod at the same speed in both directions. Therefore, the control valves 202 and 204 for the head chamber 211 must provide a larger flow path than the control valves 201 and 203 for the rod chamber 212. This is accomplished by taking advantage of the capability of the first and second hydraulic valves 10 and 70 design that allows their main poppets 24 and 86 to travel a greater distance than the respective solenoid armature 42 and 110.

That additional motion is enabled by releasing pressure within the valve's control chamber 28 or 92 which is accomplished by first and second pressure release valves 220 and 222 that are high flow, on/off type valves. Specifically, the first pressure release valve 220 is connected between the control port 59 or 95 of the second control valve 202 and when opened, relieves the pressure within the associated control chamber 28 or 92 to the tank return line 210. Thus, even after the armature has reached the extreme upward end of its travel in FIGS. 1 and 2 and the main poppet 24 or 86 engages the pilot valve element 44 or 111 which closes the pilot passage 35 or 90, the control chamber pressure is released to tank via the first pressure release valve 220. With the pressure in the control chamber 28 and 92 released, fluid pressure at the second port 20 or 82 exerts a force that causes the pilot valve element 44 or 111 to slide, or collapse, with in the armature 42 or 110. That motion allows the main poppet 24 or 86 to open farther than otherwise would be permitted by the armature of the solenoid actuator. Therefore, the second control valve 202 is able to convey a greater fluid flow from the supply line into the head chamber 211 when rapid piston movement is required.

Similarly, the second pressure release valve 222 couples the control port 59 or 95 of the fourth control valve 204 to the tank return line 210, thereby relieving any pressure within the respective control chamber 28 or 92 and allowing the associated main poppet 24 or 86 to move into a further open position. This enables the fourth control valve 204 to convey a greater fluid flow from the head chamber 211 to the tank return line 210, when rapid piston movement is required in the opposite direction.

The foregoing description was primarily directed to a preferred embodiment of the invention. Although some attention was given to various alternatives within the scope of the invention, it is anticipated that one skilled in the art will likely realize additional alternatives that are now apparent from disclosure of embodiments of the invention. Accordingly, the scope of the invention should be determined from the following claims and not limited by the above disclosure.

1. A hydraulic control valve comprising:
a body having a first port and a second port with a valve seat there between;
a main poppet that selectively engages and disengages the valve seat to control flow of fluid between the first port and the second port, and defining a control chamber on one side of the main poppet, main poppet containing a pilot passage that opens into the control chamber and is connected to the second port;
an actuator including an moveable armature that has a bore therein;
a first spring biasing the armature toward the main poppet;
a pilot poppet slideably received within the bore of the armature and selectively opening and closing the pilot passage as the armature moves; and
a second spring biasing the pilot poppet toward a position that closes the pilot passage, the second spring having a lesser spring rate than the first spring.

2. The hydraulic control valve as recited in claim 1 wherein application of a force that pushes the pilot poppet and the main poppet together which causes the second spring to yield resulting in the pilot poppet moving within the armature.

3. The hydraulic control valve as recited in claim 1 wherein the pilot poppet has a member that limits an amount that the pilot poppet is able to slide within the armature toward the main poppet.

4. The hydraulic control valve as recited in claim 1 wherein the pilot poppet comprises a stem that is received within the bore of the armature, and a head attached to the stem and selectively engaging the main poppet to open and close the pilot passage.

5. The hydraulic control valve as recited in claim 1 further comprising a valve piston received in a recess of the main poppet and having an aperture within which the pilot poppet is slideably received.

6. The hydraulic control valve as recited in claim 1 further comprising
a first pressure passage between the pilot passage and the second port;
a first flow control element in the first pressure passage allows fluid to flow only from pilot passage into the second port;
a second pressure passage in the main poppet extending between the pilot passage and the first port;
a second flow control element in the second pressure passage allows fluid to flow only from the pilot passage into the first port;
a first control passage providing communication between the first port and the control chamber;
a third flow control element in the first control passage allows fluid to flow only from the first port into the control chamber;
a second control passage extends between the second port and the control chamber; and
a fourth flow control element in the second control passage allows fluid to flow only from the second port into the control chamber.

7. The hydraulic control valve as recited in claim 6 wherein the first control passage and the second control passage are in the main poppet.

8. The hydraulic control valve as recited in claim 1 further comprising a pressure compensating mechanism which compensates operation of the pilot poppet for effects produced by a pressure differential between the pilot passage and the control chamber.

9. The bidirectional pilot operated valve as recited in claim 8 wherein the pressure compensating mechanism comprises a pilot valve seat between the pilot passage and the control chamber and moveable with respect to the main poppet, wherein pilot valve seat has a pilot orifice that is closed when the pilot poppet engages the pilot valve seat.

10. The hydraulic control valve as recited in claim 1 further comprising a pressure release valve connected to the control chamber, wherein the pressure release valve, upon being opened, relieves pressure in the control chamber which enables the main poppet to move farther from valve seat than is permitted by operation of the actuator.

11. A hydraulic control valve comprising:
a body having a first bore with a valve seat formed therein, a first port opening transversely into the first bore on one side of the valve seat, and a second port communicating with an end of the first bore on another side of the valve seat;
a main poppet that selectively engages and disengages the valve seat to control flow of fluid between the first port and the second port, and defines a control chamber within the body on one side of the main poppet, the main poppet having a pilot passage with an opening into the control chamber and with a connection to the second port;
an actuator with an armature that moves within the body and that has a second bore therein;
a first spring biasing the armature toward the main poppet;
a pilot poppet slideably received within the second bore to selectively open and close the pilot passage as the armature moves; and
a second spring biasing the pilot poppet outward from the armature and toward the main poppet;
wherein, upon engagement of the pilot poppet with the main poppet, further application of a force that pushes the pilot poppet and the main poppet together causing the second spring to collapse and the pilot poppet to slide within the armature.

12. The hydraulic control valve as recited in claim 11 wherein the first spring having a greater spring rate than the second spring.

13. The hydraulic control valve as recited in claim 11 wherein the pilot poppet has a member that limits an amount that the pilot poppet is able to travel within the armature toward the main poppet.

14. The hydraulic control valve as recited in claim 11 wherein the pilot poppet comprises a stem that is received within the bore of the armature, and a head attached to the stem and selectively engaging the main poppet to open and close the pilot passage.

15. A hydraulic control valve assembly comprising:
a body having a first port and a second port with a valve seat there between;
a main poppet that selectively engages and disengages the valve seat to control flow of fluid between the first port and the second port, and defining a control chamber on one side of the main poppet, main poppet containing a pilot passage that opens into the control chamber and is connected to the second port;
an actuator including an moveable armature that has a bore therein;
a first spring biasing the armature toward the main poppet;
a pilot poppet slideably received within the bore of the armature and selectively opening and closing the pilot passage as the armature moves;
a second spring biasing the pilot poppet toward a position that closes the pilot passage, the second spring having a lesser spring rate than the first spring; and
a pressure release valve connected to the control chamber, wherein upon being opened, the pressure release valve relieves pressure in the control chamber thereby enabling the main poppet to move farther from valve seat than is permitted by operation of the actuator.

16. The hydraulic control valve as recited in claim 15 wherein the pressure release valve is electrically operated.

17. The hydraulic control valve as recited in claim 15 wherein application of a force that pushes the pilot poppet and the main poppet together causing the second spring to yield resulting in the pilot poppet moving within the armature.

18. The hydraulic control valve as recited in claim 15 wherein the pilot poppet comprises a stem that is received within the bore of the armature, and a head attached to the stem and selectively engaging the main poppet to open and close the pilot passage.

19. The hydraulic control valve as recited in claim 15 further comprising a valve piston received in a recess of the main poppet and having an aperture within which the pilot poppet is slideably received.

20. The hydraulic control valve as recited in claim 15 further comprising
a first pressure passage between the pilot passage and the second port;
a first flow control element in the first pressure passage allows fluid to flow only from pilot passage into the second port;
a second pressure passage in the main poppet extending between the pilot passage and the first port;
a second flow control element in the second pressure passage allows fluid to flow only from the pilot passage into the first port;
a first control passage providing communication between the first port and the control chamber;
a third flow control element in the first control passage allows fluid to flow only from the first port into the control chamber;
a second control passage extends between the second port and the control chamber; and
a fourth flow control element in the second control passage allows fluid to flow only from the second port into the control chamber.

21. The hydraulic control valve as recited in claim 15 further comprising a pilot valve seat between the pilot passage and the control chamber and moveable with respect to the main poppet, wherein pilot valve seat has a pilot orifice that is closed when the pilot poppet engages the pilot valve seat.
